(19) United States
(12) Patent Application Publication
(10) Pub. No.: US 2012/0330560 A1
(43) Pub. Date: Dec. 27, 2012

(54) METHOD AND SYSTEM FOR PREDICTING PERTUBATIONS ALTERING METABOLIC STATES

(75) Inventors: Eytan RUPPIN, Reut (IL); Keren Yizhak, Netanya (IL)

(73) Assignee: Ramot at Tel-Aviv University Ltd., Tel Aviv (IL)

(21) Appl. No.: 13/532,271

(22) Filed: Jun. 25, 2012

Related U.S. Application Data
(60) Provisional application No. 61/500,247, filed on Jun. 23, 2011.

(51) Int. Cl. G06F 17/18

(52) U.S. Cl. 702/19

(57) ABSTRACT

A computer implemented method for identifying genetic or environmental perturbations that induce a transformation from a source state of an individual to a target state. A flux description of reactions is calculated in the source state and a statistical test is performed on the gene expression levels of the source state versus the target state, to generate a P-value for each on the plurality of genes. Then, for each reaction the flux of the reaction in the source state is fixed and a solution for all of the fluxes that minimize an objective function is found. These perturbations are ranked by the extent by which the perturbation caused a transformation of the source state towards the target state.

### TECHNOLOGICAL FIELD

This invention relates to computational methods in biochemistry.

### BACKGROUND

The following prior art references are considered to be relevant for an understanding of the prior art.
1. Orth, J. What is flux balance analysis? Nature Biotechnology, 28, 245-248 (2010).
2. Kenyon, C. The first long-lived mutants: discovery of the insulin/IGF-1 pathway for aging. Philosophical Transactions of the Royal Society B: Biological Sciences 366, 9-16 (2011).
3. Ingram, D. K. & Roth, G. S. Glycolytic inhibition as a strategy for developing calorie restriction mimetics. Experimental Gerontology 46, 148-154 (2011).
4. Donmez, G. & Guarente, L. Aging and disease: connections to sirtuins. Aging Cell 9, 285-290 (2010).
5. Kume, S., Uzu, T., Kashiwagi, A. & Koya, D. SIRT1, a Calorie Restriction Mimetic, in a New Therapeutic Approach for Type 2 Diabetes Mellitus and Diabetic Vascular Complications. Endocrine, Metabolic &#38; Immune Disorders—Drug Targets (Formerly Current Drug Targets—Immune, Endocrine &#38; Metabolic Disorders) 10, 16-24 (2010).
6. Kanfi, Y. et al. The sirtuin SIRT6 regulates lifespan in male mice. Nature (2012).
7. Minor, R. K., Allard, J. S., Younts, C. M., Ward, T. M. & de Cabo, R. Dietary Interventions to Extend Life Span and Health Span Based on Calorie Restriction. The Journals of Gerontology Series A: Biological Sciences and Medical Sciences 65A, 695-703 (2010).
8. Pearson, K. J. et al. Resveratrol Delays Age-Related Deterioration and Mimics Transcriptional Aspects of Dietary Restriction without Extending Life Span. Cell Metabolism 8, 157-168 (2008).
9. Kaeberlein, M. Resveratrol and rapamycin: are they anti-aging drugs? BioEssays 32, 96-99 (2010).
10. Mouchiroud, L., Molin, L., Dalliére, N. & Solari, F. Life span extension by resveratrol, rapamycin, and metformin: The promise of dietary restriction mimetics for an healthy aging. BioFactors 36, 377-382 (2010).
11. Shlomi, T., Cabili, M. N., Herrgård, M. J., Palsson, B. Ø. & Ruppin, E. Network-based prediction of human tissue-specific metabolism. Nature Biotechnology 26, 1003-1010 (2008).
12. Yiu, G. et al. Pathways Change in Expression During Replicative Aging in Saccharomyces cerevisiae. The Journals of Gerontology Series A: Biological Sciences and Medical Sciences 63, 21-34 (2008).
13. Ge, H. et al. Comparative analyses of time-course gene expression profiles of the long-lived sch9⁻″ mutant. Nucleic Acids Research 38, 143-158 (2010).
14. Burtner, C. R., Murakami, C. J., Olsen, B., Kennedy, B. K. & Kaeberlein, M. A genomic analysis of chronological longevity factors in budding yeast. Cell Cycle 10, 1385-1396 (2011).

Since the classical concept of homeostasis has been coined, the essence of medical diagnosis has been placed on viewing a disease as a disruption of normal physiological homeostasis. This naturally gives rise to the quest to find drugs that can efficiently transform a disease state back to a healthy one.

In particular, numerous constraint based modeling (CBM) methods for predicting the phenotypic effects of specific gene knock-outs (KOs) have been developed and successfully used to predict the phenotypic effects of KOs in microorganisms¹. A classical method, termed flux-balance analysis, assumes a predefined objective function, which is usually unknown when modeling human tissues. More recent knock-out prediction methods have aimed at maintaining the proximity to a given wild-type state, assuming that the organism's regulatory system has evolved to maintain its homeostasis. Importantly, this assumption does not hold for describing perturbations that take the system from a diseased state to a healthy one or vice versa, since these transformations involve a cardinal disruption of the system's homeostasis.

Aging is typically accompanied by genome-wide changes in gene expression, where lowered expression of metabolic and biosynthetic genes plays a key role. Interestingly, it has been shown that Caloric Restriction (CR), a dietary intervention that reliably extends lifespan, opposes the development of many of these age-associated gene expression changes. While CR is of limited utility therapeutically, these findings have strongly motivated the search for agents that have a similar effect as CR such as the insulin-like growth factor 1 (IGF-1)^{2,3}, the sirtuin (SIRT1) activator³⁻⁶, resveratrol^{7,8}, and the mammalian target of rapamycin (mTOR)^{9,10}. These agents act to extend the life and health span of humans by counteracting metabolic alterations in aging.

As used herein, the term “metabolic model” of an organism is used to refer to a network of biochemical reactions that can, at least in potential, occur in the organism. For each biochemical reaction in the model, the model also includes one or more genes encoding for one or more enzymes catalyzing the reaction. For example, iAF1260 is a metabolic model of E. coli, iMM904 is a yeast metabolic model, Recon1 is a human metabolic model.

Constraint-Based Modeling (CBM) receives as an input a metabolic model of an organism and a set of governing constraints on the space of possible metabolic behaviors defined by the model. CBM generates an output of levels of one or more predetermined metabolic phenotypes, such as growth rates, nutrient uptake rates, by-product secretion and gene essentiality. CBM has been used in a variety of applications including drug discovery, understanding network robustness and metabolic engineering tasks. Over the last five years, CBM has been successfully used for modeling human metabolism both in health and disease. The numerous arising applications of CBM for modeling human metabolism have been recently comprehensively reviewed in.

### GENERAL DESCRIPTION

The present invention provides a method, referred to herein as the “Metabolic Transformation Algorithm” (MTA) that identifies genetic or environmental perturbations that induce a transformation from a source state (sometimes referred to herein as the “diseased state” or the “aged state”) of an individual to a target state (sometimes referred to herein as “the healthy state” or the “young state”) of the individual. The method receives as an input a metabolic model and gene expression levels of the genes in the model in the source state and in the target state.

In accordance with the invention, a search is performed on reactions in the model for reactions whose perturbation in the source sate can induce a transformation of the metabolic state of the organism from the source state to the target state. The method produces as an output a perturbation that tends to shift the fluxes of the changed reactions in the right direction while keeping the fluxes of the unchanged reactions as close as possible to the source state.

Thus in one of its aspects, the present invention comprises a computer implemented method for identifying genetic or environmental perturbations that induce a transformation from a source state of an individual to a target state, the method embodied in a set of instructions stored on a computer readable medium, the instructions capable of being executed by a computer processor, the method, comprising:
(a) inputting expression levels of a plurality of genes in the source state of the individual an in the target state of the individual;
(b) calculating a flux description of reactions in the source state utilizing a first CBM method, the first CBM method integrating the gene expression levels of the source state to predict a most-likely distribution of metabolic fluxes;
(c) performing a statistical test on the gene expression levels of the source state versus the target state, to generate a P-value for each on the plurality of genes;
(d) dividing the plurality of genes into an “increased subset”, consisting of genes whose expression level increased significantly from the source state to the target state as determined by the P-value of the gene, a “decreased subset”, consisting of genes whose expression level decreased significantly from the source state to the target state as determined by the P-value of the gene, and an “unchanged subset” consisting of genes whose expression remained essentially unchanged from the source state to the target state as determined by the P-value of the gene;
(e) calculating constraints for the first CBM method;
(f) for each reaction:
   (i) fixing the value of the flux of the reaction in the source state as calculated in step (b);
   (ii) calculating, by a second CBM method and the determined constraints, a solution for all of the fluxes that minimize a predetermined objective function, the predetermined objective function involving the number of increases in the fluxes in the increased subset, the number of decreases in the decreased subset and the number of unchanged fluxes in the unchanged subset;
   (iii) calculating a transformation score (TS) to the solution obtained for each perturbation indicative of the extent by which the perturbation caused a transformation of the source state towards the target state;
(g) ranking the perturbations according to their scores; and
(h) selecting one or more, and perturbations having a score above a predetermined threshold.

In the method of the invention, one or both of the first CBM method and the second CBM method may be a Mixed Integer Quadratic Programming (MIQP) algorithm. One or both of the first CBM method and the second CBM method may be iMAT. The CBM method may integrate gene expression levels of the source state to predict a most-likely distribution of metabolic fluxes. The statistical test may be, for example, a student's t test.

The scoring function may be given, for example, by

$$\frac{{\sum }_{i ∈ {R}_{success}} abs [ ( {v}_{i}^{ref} - {v}_{i}^{res} ) ] - {\sum }_{i ∈ {R}_{unsuccess}} abs [ ( {v}_{i}^{ref} - {v}_{i}^{res} ) ]}{{\sum }_{i ∈ {R}_{S}} abs ( {v}_{i}^{ref} - {v}_{i}^{res} )}$$

wherein R_{success} is the set of reactions that achieved a change in flux rate in a required direction; R_{unsuccess} is the set of reactions that did not achieved a change in flux rate in a required direction, R_{S} is the reactions in the unchanged subset, and v^{ref} is the resulting flux distribution.

In another of its aspects, the invention provides a computer implemented program storage device readable by machine, tangibly embodying a program of instructions executable by the machine to perform a method for identifying genetic or environmental perturbations that induce a transformation from a source state of an individual to a target state, the method, comprising:
(a) inputting expression levels of a plurality of genes in the source state of the individual an in the target state of the individual;
(b) calculating a flux description of reactions in the source state utilizing a first CBM method, the first CBM method integrating the gene expression levels of the source state to predict a most-likely distribution of metabolic fluxes;
(c) performing a statistical test on the gene expression levels of the source state versus the target state, to generate a P-value for each on the plurality of genes;
(d) dividing the plurality of genes into an “increased subset”, consisting of genes whose expression level increased significantly from the source state to the target state as determined by the P-value of the gene, a “decreased subset”, consisting of genes whose expression level decreased significantly from the source state to the target state as determined by the P-value of the gene, and an “unchanged subset” consisting of genes whose expression remained essentially unchanged from the source state to the target state as determined by the P-value of the gene;
(e) calculating constraints for the first CBM method;
(f) for each reaction:
   (i) fixing the value of the flux of the reaction in the source state as calculated in step (b);
   (ii) calculating, by a second CBM method and the determined constraints, a solution for all of the fluxes that minimize a predetermined objective function, the predetermined objective function involving the number of increases in the fluxes in the increased subset, the number of decreases in the decreased subset and the number of unchanged fluxes in the unchanged subset;
   (iii) calculating a transformation score (TS) to the solution obtained for each perturbation indicative of the extent by which the perturbation caused a transformation of the source state towards the target state;
(g) ranking the perturbations according to their scores; and
(h) selecting one or more, and perturbations having a score above a predetermined threshold.

The invention further provides a computer implemented computer program product comprising a computer usable medium having computer readable program code embodied therein for identifying genetic or environmental perturbations that induce a transformation from a source state of an individual to a target state, the computer program product comprising:

computer readable program code for causing the computer to input expression levels of a plurality of genes in the source state of the individual an in the target state of the individual;

computer readable program code for causing the computer to calculate a flux description of reactions in the source state utilizing a first CBM method, the first CBM method integrating the gene expression levels of the source state to predict a most-likely distribution of metabolic fluxes;

computer readable program code for causing the computer to perform a statistical test on the gene expression levels of the source state versus the target state, to generate a P-value for each on the plurality of genes;

computer readable program code for causing the computer to divide the plurality of genes into an “increased subset”, consisting of genes whose expression level increased significantly from the source state to the target state as determined by the P-value of the gene, a “decreased subset”, consisting of genes whose expression level decreased significantly from the source state to the target state as determined by the P-value of the gene, and an “unchanged subset” consisting of genes whose expression remained essentially unchanged from the source state to the target state as determined by the P-value of the gene;

computer readable program code for causing the computer to calculate constraints for the first CBM method;

computer readable program code for causing the computer, for each reaction:

to fix the value of the flux of the reaction in the source state as calculated in step (b);

calculate, by a second CBM method and the determined constraints, a solution for all of the fluxes that minimize a predetermined objective function, the predetermined objective function involving the number of increases in the fluxes in the increased subset, the number of decreases in the decreased subset and the number of unchanged fluxes in the unchanged subset;

computer readable program code for causing the computer to calculate a transformation score (TS) to the solution obtained for each perturbation indicative of the extent by which the perturbation caused a transformation of the source state towards the target state;

computer readable program code for causing the computer to rank the perturbations according to their scores; and

computer readable program code for causing the computer to select one or more, and perturbations having a score above a predetermined threshold.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 shows a method for predicting perturbations capable of altering metabolic states, in accordance with one embodiment of the invention;

FIG. 2A shows genetic perturbations datasets (gene knock-outs in E. coli, mouse and human cell lines;

FIG. 2B shows environmental perturbations of different carbon sources in E. coli and yeast;

FIG. 3 shows pathway enrichment analysis within the top 10% of knock-out predictions in five datasets; and

FIG. 4 depicts a block diagram of a host computer system suitable for implementing the present invention.

### DETAILED DESCRIPTION OF EMBODIMENTS

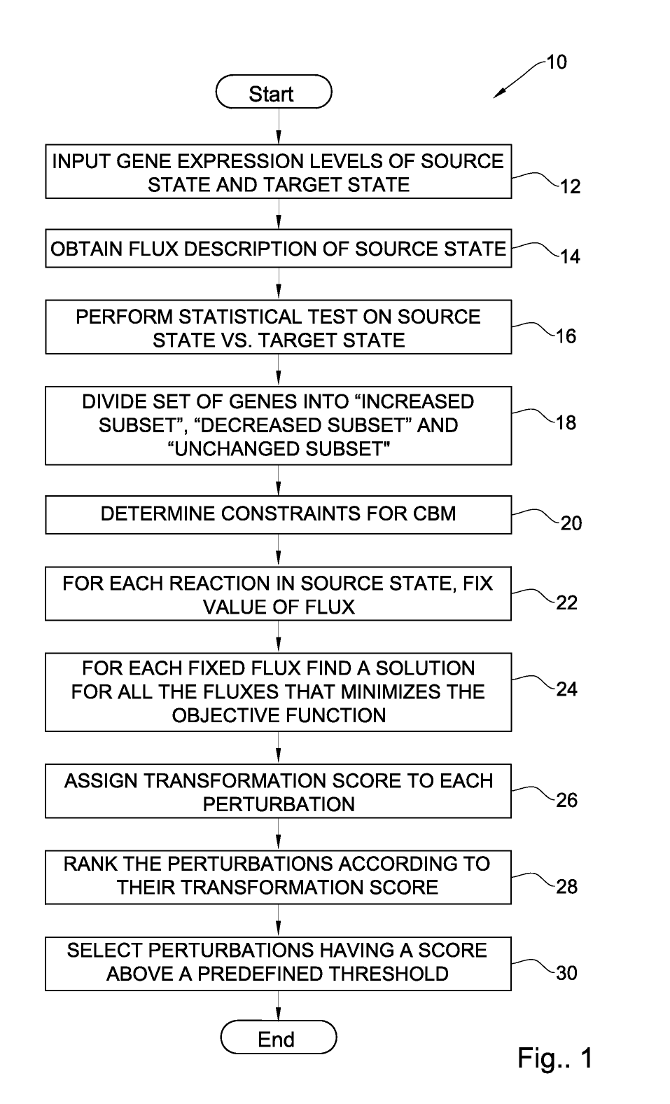

FIG. 1 shows a flow chart 10 for a method of identifying genetic or environmental perturbations that induce a transformation from a source state of an individual to a target state, in accordance with one embodiment of the invention. The method begins in step 12 by inputting gene expression levels of the source state and the target state. Then in step 14 a flux description of the source state is obtained utilizing a CBM method such as iMAT¹¹, which integrates the gene expression levels of the source state to predict a most-likely distribution of metabolic fluxes. A statistical test, such as a student's t test, is then performed in step 16, on the gene expression levels of the source state vs. the target state. The statistical test provides as an output a P-value for each gene in the model. Then in step 18 the set of genes in the model is divided into three subsets. One subset, referred to as the “increased subset”, consists of genes whose expression level increased significantly from the source state to the target state as determined by the P-value of the gene. The second subset, referred to as the “decreased subset”, consists of genes whose expression level decreased significantly from the source state to the target state as determined by the P-value of the gene. The third subset, referred to as the “unchanged subset”, consists of genes whose expression remained essentially unchanged from the source state to the target state as determined by the P-value of the gene.

Now, in step 20, the constraints for CBM are determined, for example, using a Mixed Integer Quadratic Programming (MIQP) algorithm. The value of the flux of each reaction in the source state is then individually fixed (step 22), and CBM, utilizing the determined constraints is then used to find a solution for all of the fluxes that minimizes a predetermined objective function involving the number of increases in the fluxes in the increased subset, the number of decreases in the decreased subset and the number of unchanged fluxes in the unchanged subset. A transformation score (TS) is then assigned in step 26 to the solution obtained for each perturbation indicative of the extent by which the perturbation caused a transformation of the source state towards the target state. The perturbations are then ranked according to their scores (step 28), and perturbations having a score above a predetermined threshold are selected (step 30).

### EXAMPLES

Methods

A Constraint Based Model (CBM) of a Metabolic Network

A metabolic network consisting of m metabolites and n reactions can be represented by a stoichiometric matrix, S, where the entry Sᵢⱼ represents the stoichiometric coefficient of metabolite i in reaction j. A CBM model imposes mass balance, directionality and flux capacity constraints on the space of possible fluxes in the metabolic network's reactions through a set of linear equations

S·v=0 (1)

vₘᵢₙ≦v≦vₘₐₓ (2)

Where v stands for the flux vector for all of the reactions in the model (i.e. the flux distribution). The exchange of metabolites with the environment is represented as a set of exchange (transport) reactions, enabling a pre-defined set of metabolites to be either taken up or secreted from the growth media. The steady-state assumption represented in Equation (1) constrains the production rate of each metabolite to be equal to its consumption rate. Enzymatic directionality and flux capacity constraints define lower and upper bounds on the fluxes and are embedded in Equation (2). In the following, flux vectors satisfying these conditions will be referred to as feasible steady-state flux distributions. Gene knock-outs are simulated by constraining the flux through the corresponding metabolic reaction to zero. Similarly, environmental perturbations are simulated by constraining the flux through the associated exchange reaction to zero.

Preprocessing of Gene Expression Data and Its Integration with the Metabolic Network Model (Steps 1 and 2 in MTA)

Given a metabolic network model and gene expression levels of the source and target metabolic states, the following preprocessing steps are performed: (1) Determining the baseline flux distribution at the source state (v^{ref}) by utilizing iMAT ¹²with the source gene expression data, (2) Analyzing the source and target gene expression data to determine the set of unchanged (denoted as R_{S}) and changed reactions, and (3) Assigning directionality to changed reactions (i.e., change in either forward or backward direction, denoted as R_{F} and R_{B}).

The Metabolic Transformation Algorithm (MTA) (Steps 3 & 4)

As the desired transformation score (described below in step 4) is non-linear, it preferably should not be used directly as the objective function. More preferably is to take a 2-step heuristic approach: in step 3, an objective function is first minimized maximize the changes in the ‘changed’ reactions while keeping the flux on the ‘unchanged’ ones unchanged). Subsequently, in step 4, the solutions obtained in step 3 were ranked by the (non-linear) transformation score that, tends to produce a more refined and accurate ranking of the KO predictions than the original objective.

A Mixed Integer Quadratic Programming (MIQP) Formulation for Finding Proxy KO Predictions (Step 3)

For each employed genetic or environmental perturbation vⱼ, the following Mixed Integer Quadratic Programming (MIQP) problem to find a steady-state flux distribution satisfying stoichiometric and thermodynamic constraints were formulated that: (1) aims to keep the flux through reaction in R_{S} as similar as possible to their value embedded in v^{ref}, and (2) maximizes the number of reactions in R_{F} and R_{B} whose flux is elevated or reduced significantly in the desired direction, with respect to the flux in v^{ref}:

$$\begin{matrix}{min}_{v , y} ( {\sum }_{i ∈ {R}_{S}} {( {v}_{i}^{ref} - {v}_{i} )}^{2} + {\sum }_{i ∈ {R}_{F}} {y}_{i} + {\sum }_{i ∈ {R}_{B}} {y}_{i} ) & \\ s . t & \\ S \cdot v = 0 & ( 1 ) \\ {v}_{min} \leq v \leq {v}_{max} & ( 2 ) \\ {v}_{j} = 0 & ( 3 ) \\ {v}_{i} {y}_{i}^{F} ( {v}_{i}^{ref} + ɛ ) - {y}_{i} {v}_{i}^{min} \geq 0 , i ∈ {R}_{F} & ( 4 ) \\ {y}_{i}^{F} + {y}_{i} = 1 , i ∈ {R}_{F} & ( 5 ) \\ {v}_{i} - {y}_{i}^{B} ( {v}_{i}^{ref} + ɛ ) - {y}_{i} {v}_{i}^{max} \leq 0 , i ∈ {R}_{S} & ( 6 ) \\ {y}_{i}^{B} \vert {y}_{i} = 1 , i ∈ {R}_{S} & ( 7 ) \\ {y}_{i} , {y}_{i}^{F} , {y}_{i}^{B} ∈ \{ 0 , 1 \} & ( 8 )\end{matrix}$$

The mass balance and thermodynamic (directionality) constraints are enforced in equations (1) and (2), respectively. The employed perturbation is enforced through equation (3). For each significantly changed reaction, the Boolean variables yᵢ^{F}, yᵢ^{B}, yᵢ represent whether the flux through the corresponding reaction is changed significantly (in either direction) or not. Specifically, a reaction that is required to change in the forward direction in order to transform from the source to the target metabolic state, satisfies this demand if its flux is elevated by more than an ε with respect to the flux embedded in v^{ref} (equations (4) and (5)). Similarly, a reaction that is required to change in the backward direction in order to perform a transformation between the two states, satisfies this demand if its flux is reduced by more than an ε with respect to the flux in v^{ref} (equations (6) and (7)). In order to comprehensively capture the transformation from one state to the other, the optimization function also aims at minimizing the change in flux rate with respect to v^{ref} for reactions found in R_{S}. Over all, the optimization problem minimizes the change in flux rate through the reactions that should remain unchanged while maximizing the number of reactions whose corresponding flux should differ significantly in order to transform from the source to the target state. The commercial CPLEX solver was used for solving MIQP problems on a Pentium-4 machine running Linux, and solution usually took a few milliseconds per problem.

The Transformation Score: Quantifying the Success of a Transformation from the Source to the Target State (Step 4)

Relying on the optimization value obtained by MTA to rank the transformations induced by different perturbations can be suboptimal, since the integer-based scoring of the changed reactions is coarse-grained and does not distinguish between solutions achieving large flux alterations and those obtaining flux changes barely crossing the ε threshold. Therefore, the success of a transformation was quantified by a scoring function based on the resulting flux distribution rather than on the optimization value itself. First, we denote the resulting flux distribution as v^{ref} (the latter is almost always unique, due to the QP constraints). Second, reactions found in R_{F} and R_{B} are classified into two groups R_{success} and R_{unsuccess} corresponding to whether they achieved a change in flux rate in the required direction (forward or backward) or not. The following scoring function is then used to assess the global change achieved by the employed perturbation:

$$\frac{{\sum }_{i ∈ {R}_{success}} abs [ ( {v}_{i}^{ref} - {v}_{i}^{res} ) ] - {\sum }_{i ∈ {R}_{unsuccess}} abs [ ( {v}_{i}^{ref} - {v}_{i}^{res} ) ]}{{\sum }_{i ∈ {R}_{S}} abs ( {v}_{i}^{ref} - {v}_{i}^{res} )} \qquad ( 9 )$$

The numerator of this function is the sum over the absolute change in flux rate for all reaction in R_{success}, minus a similar sum for reactions in R_{unsuccess}. The denominator is then the corresponding sum over reactions in R_{S} (the reactions which should stay untransformed). Following this definition, perturbations achieving the highest scores are the ones most likely to perform a successful transformation by both maximizing the change in flux rate for significantly changed reactions, and minimizing the corresponding change in flux of unchanged reactions. Using an alternative scoring function based on the Euclidean distance instead of absolute values yielded similar results.

Results

Examples

The method of the invention was applied to predict the effects of gene knock-outs in Escherichia coli, mouse and human. An experiment was performed in which gene expression data were measured before and after each of a plurality of specific metabolic gene knock-outs, and the method of the invention was applied to the measured data in order to determine the ability of the method to correctly identify the underlying knock-out which generated the data.

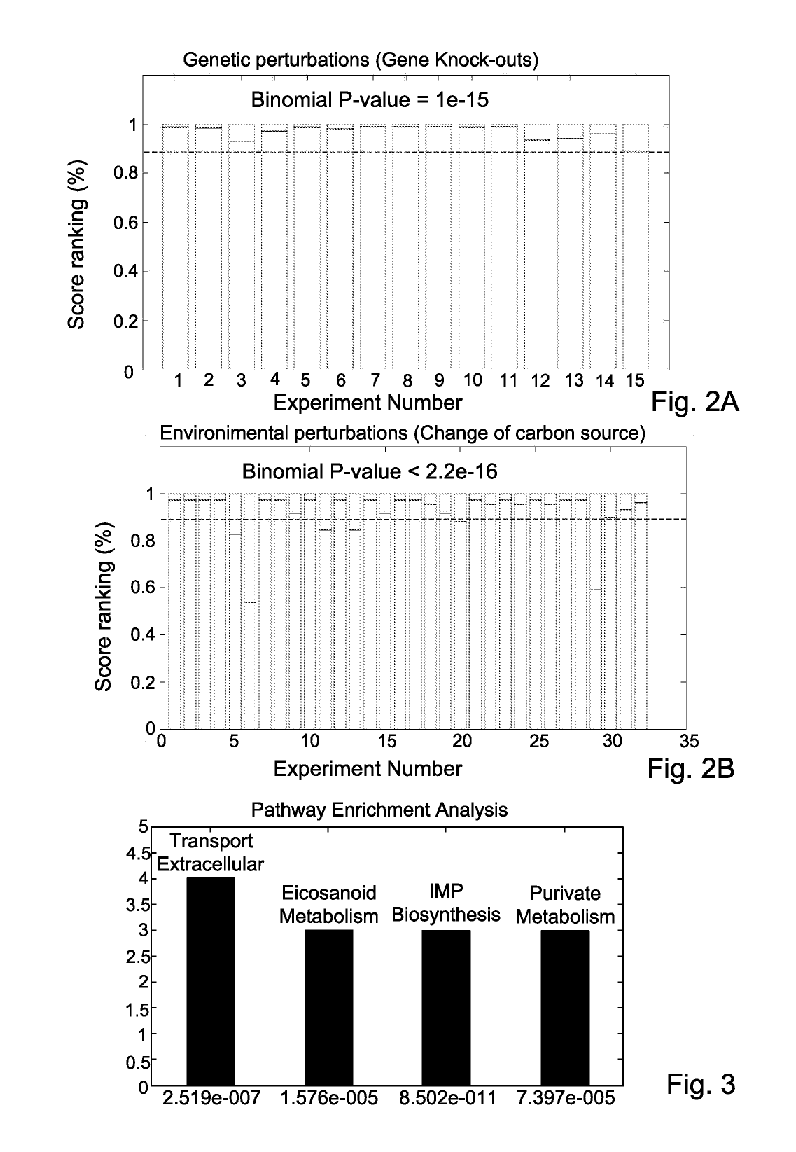

FIG. 2 shows bar plots summarizing MTA's validation analysis. FIG. 2a shows the results obtained for genetic perturbations datasets (gene knock-outs), where bars 1 to 11 correspond to data measured in E. coli, bars 12-13 to mouse and 14-15 to human cell lines. The horizontal bars represent the ranking of the transformation score of the correct, underlying knock-out predicted by the method of the invention (normalized here to a value in the range [0 1]) amongst all other simulated knock-outs. In all cases, the correct knock-out was ranked within the top 10% predictions (dashed line, Binomial P-value=1e-15 with p=0.1). FIG. 2B shows the results obtained under environmental perturbations of different carbon sources, where bars 1 to 29 describe the results for E. coli and bars 30 to 32 for yeast. In 26 of the 32 experiments examined, the correct carbon source is ranked within the top 10% predictions (Binomial P-value<2.2e-16 with p=0.1).

Predicting and Validating Metabolic Targets Extending Lifespan in Yeast

The budding yeast Saccharomyces cerevisiae is a widely used model of cellular aging, and there is increasing evidence that pathways influencing longevity in yeast are conserved in other eukaryotes, including mammals The invention was applied to analyze gene expression data of young and aging yeast obtained from an assay examining their Replicative Life Span (RLS) ¹²and from an assay examining their Chronological Life Span (CLS)¹³, predicting reactions whose knock-out transform the aged metabolic state towards that of the young state. A significant enrichment with a curated list of known lifespan-extending metabolic genes in yeast was found in predictions made by the invention on both datasets (P-value<0.03,).

Predicting Metabolic Targets in Aging Mammalian Muscle

The invention was applied to analyze gene expression data from one data set of old and young mouse, and four data sets of old and young human muscle tissue.

Pathway enrichment analysis within the top 10% of the knock-out predictions according to the five datasets was performed, and the results are shown in FIG. 3. Eicosanoid metabolism, IMP (inosine monophosphate) biosynthesis and pyruvate metabolism were found to be enriched in three of the datasets, and extracellular transport was found to be enriched in four out of the five datasets. The mean P-value of each of these pathways across the different datasets is listed at the bottom of each bar.

Moreover, top predicted reactions can significantly reverse a significant portion of the aging-related changes in all datasets. Most of the predicted KOs do not reduce the production of key currency metabolites such as ATP, NADP and NADPH according to the model. Performing a leave-one-out-cross-validation analysis amongst the individual samples composing each dataset, the KO predictions were found to be highly robust. The intersection found above between the predictions vanishes when the data is randomized.

A primary pathway predicted by MTA in the majority of the datasets analyzed here is eicosanoid metabolism. This pathway is known to be controlled by dietary fat and insulin and has widespread effects on many alterations occurring in aging, such as cardiovascular disease, triglycerides, blood pressure, arthritis and inflammation. Interestingly, resveratrol, a substance that was found to mimic the effects of CR and to extend the lifespan of obese mice, is thought to exert anti-inflammatory effects through the inhibition of two key enzymes associated with eicosanoids biosynthesis, COX-1 and 5-lipoxygenase). A brief description of the predicted network level effects of the KO of this pathway and how they alter metabolism to counter aging alterations is provided in the caption of FIG. 5. MTA's predictions also include inosine monophosphate (IMP) biosynthesis, whose inhibition was previously found to extend the chronological lifespan of yeast via the allosteric regulation of phosphofructokinase. Here, the knock-out of IMP pathway induces higher levels of α-D-Ribose-5-phosphate (a substrate involved in IMP production) that enable increased pyrimidine biosynthesis, an essential component in maintaining mitochondrial integrity. The set of genes predicted by the method of the invention as being capable of transforming old mammalian muscle cells into young muscles cells, is enriched with known lifespan extending genes in yeast and c. elegans collated from the Sacchromyces Genome Database and from (P-value<0.04). Finally, the invention was also employed to analyze aging expression data in additional human tissues. As the aging signature across tissues is distinct⁵⁵, the emerging predictions are different from those found for the muscle datasets.

Predicting the Effects of Environmental Perturbations

The invention was applied to predict the effects of nutrient-supply deficiencies on transforming the metabolic state of aging muscle tissue. Investigating the effects of combined knock-outs in transport reactions and top single knock-outs identified earlier, synergistic combinations were sought whose knock-out transformation score is higher than the sum of the knock-out scores of each reaction alone. Highly ranked knock-outs included the transport of methionine and tryptophan, whose deficiency in diet was shown to extend lifespan and of sucrose, whose dietary effects were found to significantly affect the health and lifespan of elderly people. To investigate the hypothesis that it is not the reduction of calories that mediates the extension of lifespan, but the restriction of particular nutrient groups in the diet, the transport reactions were clustered into the three major nutrient groups (amino acids, fatty acids and carbohydrates). It was found that the dietary elimination of amino acids is the most beneficial and that of carbohydrates to be the least so P-value<0.001).

Computer Implementation

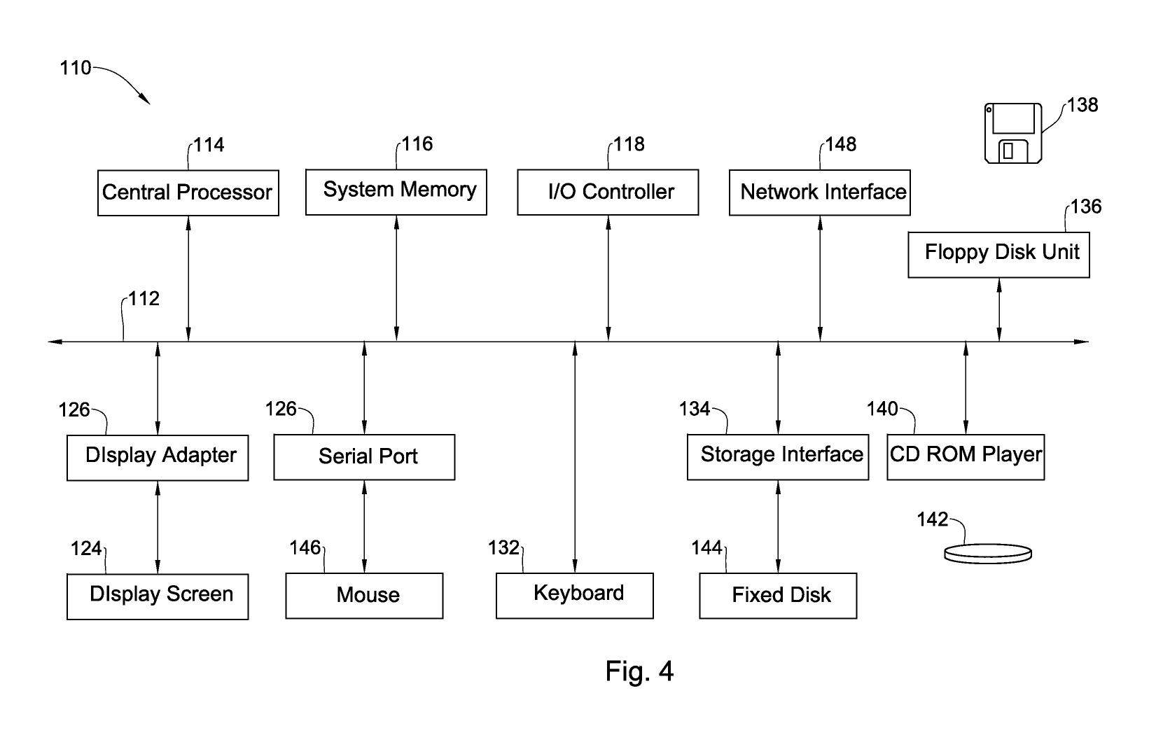

FIG. 4 depicts a block diagram of a host computer system 110 suitable for implementing the present invention. This diagram is merely an illustration and should not limit the scope of the claims herein. One of ordinary skill in the art would recognize other variations, modifications, and alternatives. Host computer system 110 includes a bus 112 which interconnects major subsystems such as a central processor 114, a system memory 116 (typically RAM), an input/output (I/O) controller 118, an external device such as a to display screen 124 via a display adapter 126, a keyboard 132 and a mouse 146 via an I/O controller 118, a SCSI host adapter (not shown), and a floppy disk drive 136 operative to receive a floppy disk 138. Storage Interface 134 may act as a storage interface to a fixed disk drive 144 or a CD-ROM player 140 operative to receive a CD-ROM 142. Fixed disk 144 may be a part of host computer system 110 or may be separate and accessed through other interface systems.

The system has other features. A network interface 148 may provide a direct connection to a remote server via a telephone link or to the Internet. Network interface 148 may also connect to a local area network (LAN) or other network interconnecting many computer systems. Many other devices or subsystems (not shown) may be connected in a similar manner. Also, it is not necessary for all of the devices shown in FIG. 4 to be present to practice the present invention, as discussed below. The devices and subsystems may be interconnected in different ways from that shown in FIG. 4. The operation of a computer system such as that shown in FIG. 4 is readily known in the art and is not discussed in detail in this application. The databases and code to implement the present invention may be operably disposed or stored in computer-readable storage media such as system memory 116, fixed disk 144, CD-ROM 140, or floppy disk 138.

Although the above has been described generally in terms of specific hardware, it would be readily apparent to one of ordinary skill in the art that many system types, configurations, and combinations of the above devices are suitable for use in light of the present disclosure. Of course, the types of system elements used depend highly upon the application.

Likewise, the invention contemplates a computer program being readable by a computer for executing the method of the invention. The invention further contemplates a machine-readable memory tangibly embodying a program of instructions executable by the machine for executing the method of the invention.

1. A computer implemented method for identifying genetic or environmental perturbations that induce a transformation from a source state of an individual to a target state, the method embodied in a set of instructions stored on a computer readable medium, the instructions capable of being executed by a computer processor, the method, comprising:
(a) inputting expression levels of a plurality of genes in the source state of the individual an in the target state of the individual;
(b) calculating a flux description of reactions in the source state utilizing a first CBM method, the first CBM method integrating the gene expression levels of the source state to predict a most-likely distribution of metabolic fluxes;
(c) performing a statistical test on the gene expression levels of the source state versus the target state, to generate a P-value for each on the plurality of genes;
(d) dividing the plurality of genes into an “increased subset”, consisting of genes whose expression level increased significantly from the source state to the target state as determined by the P-value of the gene, a “decreased subset”, consisting of genes whose expression level decreased significantly from the source state to the target state as determined by the P-value of the gene, and an “unchanged subset” consisting of genes whose expression remained essentially unchanged from the source state to the target state as determined by the P-value of the gene;
(e) calculating constraints for the first CBM method;
(f) for each reaction:
(i) fixing the value of the flux of the reaction in the source state as calculated in step (b);
(ii) calculating, by a second CBM method and the determined constraints, a solution for all of the fluxes that minimize a predetermined objective function, the predetermined objective function involving the number of increases in the fluxes in the increased subset, the number of decreases in the decreased subset and the number of unchanged fluxes in the unchanged subset;
(iii) calculating a transformation score (TS) to the solution obtained for each perturbation indicative of the extent by which the perturbation caused a transformation of the source state towards the target state;
(g) ranking the perturbations according to their scores; and
(h) selecting one or more, and perturbations having a score above a predetermined threshold.

2. The method according to claim 1 wherein one or both of the CBM method is a Mixed Integer Quadratic Programming (MIQP) algorithm.

3. The method according to claim 1 wherein one or both of the CBM method is iMAT.

4. The method according to claim 1 wherein the statistical test is a student's t test.

5. The method according to claim 1 wherein the CBM method integrates the gene expression levels of the source state to predict a most-likely distribution of metabolic fluxes.

6. The method according to claim 1 wherein the scoring function is given by
$$\frac{{\sum }_{i ∈ {R}_{success}} abs [ ( {v}_{i}^{ref} - {v}_{i}^{res} ) ] - {\sum }_{i ∈ {R}_{unsuccess}} abs [ ( {v}_{i}^{ref} - {v}_{i}^{res} ) ]}{{\sum }_{i ∈ {R}_{S}} abs ( {v}_{i}^{ref} - {v}_{i}^{res} )}$$
wherein R_{success} is the set of reactions that achieved a change in flux rate in a required direction; R_{unsuccess} is the set of reactions that did not achieved a change in flux rate in a required direction, R_{S} is the reactions in the unchanged subset, and v^{ref} is the resulting flux distribution.

7. A computer implemented program storage device readable by machine, tangibly embodying a program of instructions executable by the machine to perform a method for identifying genetic or environmental perturbations that induce a transformation from a source state of an individual to a target state, the method, comprising:
(a) inputting expression levels of a plurality of genes in the source state of the individual an in the target state of the individual;
(b) calculating a flux description of reactions in the source state utilizing a first CBM method, the first CBM method integrating the gene expression levels of the source state to predict a most-likely distribution of metabolic fluxes;
(c) performing a statistical test on the gene expression levels of the source state versus the target state, to generate a P-value for each on the plurality of genes;
(d) dividing the plurality of genes into an “increased subset”, consisting of genes whose expression level increased significantly from the source state to the target state as determined by the P-value of the gene, a “decreased subset”, consisting of genes whose expression level decreased significantly from the source state to the target state as determined by the P-value of the gene, and an “unchanged subset” consisting of genes whose expression remained essentially unchanged from the source state to the target state as determined by the P-value of the gene;
(e) calculating constraints for the first CBM method;
(f) for each reaction:
(i) fixing the value of the flux of the reaction in the source state as calculated in step (b);
(ii) calculating, by a second CBM method and the determined constraints, a solution for all of the fluxes that minimize a predetermined objective function, the predetermined objective function involving the number of increases in the fluxes in the increased subset, the number of decreases in the decreased subset and the number of unchanged fluxes in the unchanged subset;
(iii) calculating a transformation score (TS) to the solution obtained for each perturbation indicative of the extent by which the perturbation caused a transformation of the source state towards the target state;
(g) ranking the perturbations according to their scores; and
(h) selecting one or more, and perturbations having a score above a predetermined threshold.

8. A computer implemented computer program product comprising a computer usable medium having computer readable program code embodied therein for identifying genetic or environmental perturbations that induce a transformation from a source state of an individual to a target state, the computer program product comprising:
computer readable program code for causing the computer to input expression levels of a plurality of genes in the source state of the individual an in the target state of the individual;
computer readable program code for causing the computer to calculate a flux description of reactions in the source state utilizing a first CBM method, the first CBM method integrating the gene expression levels of the source state to predict a most-likely distribution of metabolic fluxes;
computer readable program code for causing the computer to perform a statistical test on the gene expression levels of the source state versus the target state, to generate a P-value for each on the plurality of genes;
computer readable program code for causing the computer to divide the plurality of genes into an “increased subset”, consisting of genes whose expression level increased significantly from the source state to the target state as determined by the P-value of the gene, a “decreased subset”, consisting of genes whose expression level decreased significantly from the source state to the target state as determined by the P-value of the gene, and an “unchanged subset” consisting of genes whose expression remained essentially unchanged from the source state to the target state as determined by the P-value of the gene;
computer readable program code for causing the computer to calculate constraints for the first CBM method;
computer readable program code for causing the computer, for each reaction:
to fix the value of the flux of the reaction in the source state as calculated in step (b);
calculate, by a second CBM method and the determined constraints, a solution for all of the fluxes that minimize a predetermined objective function, the predetermined objective function involving the number of increases in the fluxes in the increased subset, the number of decreases in the decreased subset and the number of unchanged fluxes in the unchanged subset;
computer readable program code for causing the computer to calculate a transformation score (TS) to the solution obtained for each perturbation indicative of the extent by which the perturbation caused a transformation of the source state towards the target state;
computer readable program code for causing the computer to rank the perturbations according to their scores; and
computer readable program code for causing the computer to select one or more, and perturbations having a score above a predetermined threshold.
